(19) United States
(12) Patent Application Publication
(10) Pub. No.: US 2023/0281146 A1
(43) Pub. Date: Sep. 7, 2023

(54) Kitchen Appliance, Accessory for a Kitchen Appliance, System and Method for Operating a Kitchen Appliance

(71) Applicant: Vorwerk & Co. Interholding GmbH, Wuppertal (DE)

(72) Inventors: Nils Beckmann, Remscheid (DE); Kevin Schmitz, Haan-Gruiten (DE); Miron Sernecki, Hagen (DE)

(21) Appl. No.: 18/117,732

(22) Filed: Mar. 6, 2023

(30) Foreign Application Priority Data
Mar. 7, 2022 (EP) 22160523.1

(51) Int. Cl. G06F 13/40; H04W 4/80; A47J 36/34

(52) U.S. Cl. CPC G06F 13/4068; H04W 4/80; A47J 36/34

(57) ABSTRACT

The invention relates to a kitchen appliance with a base unit including a housing, an electric motor, a detector, a controller and a communication interface, and with at least one accessory having an identification feature. The controller is configured to recognise an accessory on the basis of a detected identification feature and to display corresponding cooking information and also, on the first use of this accessory, to then automatically register it in a database. Also described are a system including a Kitchen appliance and having a database, an accessory having an integrated data carrier, an operating method and a computer program.

### CROSS-REFERENCE TO RELATED APPLICATION

This application claims priority to European Patent Application No. 22160523.1 filed Mar. 7, 2022, the disclosure of which is hereby incorporated by reference in its entirety.

### BACKGROUND OF THE INVENTION

### Field of the Invention

The invention relates to a kitchen appliance with a base unit comprising a housing, an electric motor, a detection device, a control device and a communication interface, and with at least one accessory comprising an identification feature. Also described are an accessory, a system and a method for operating such a kitchen appliance, and a corresponding computer program.

### Description of Related Art

Electrically operated kitchen appliances are already known, especially for processing raw or semi-finished food products. Such kitchen appliances often have a base unit with which separate functional parts interact to process a food product depending on the dish, beverage or the like achieved. These functional parts are usually sold by kitchen appliance suppliers as accessories, for example as a cooking vessel, knife or stirring unit.

In order to keep the manufacturing costs of these accessories low and thus also increase the profitability of the accessory business, the base unit should be versatile and have as many of the more cost-intensive components as possible, such as the electric motor for driving the moving parts of the accessories or a control device. Such a design, however, enables competitors to offer accessories that are compatible with the cost-intensive base unit and are inexpensive to manufacture. This problem has already been solved in the past, at least partially, by attaching a fluorescent dye to the accessory, the pigments of which recognise a corresponding detection and processing equipment on the base unit as “permissible”. This solution is explained in detail in the publication DE 10 2013 111 472 A1. If an accessory does not have such a dye, a function of the kitchen appliance is then blocked or prevented, and thus the kitchen appliance cannot be used when using an imitation without the special pigments.

In addition, the user-friendliness of a kitchen appliance is an important selling point. Thus, kitchen appliances are known that offer digital assisted cooking. For example, WO 2018/201653 A1 discloses a kitchen appliance that recognises the type of an accessory and suggests suitable cooking information to the user.

However, the well-known kitchen appliances have the disadvantage that with each use and despite automatic registration of the accessory type, numerous user entries are required until suitable cooking information is actually made available. As a rule, the accessory has to be registered by entering a registration code in a user portal and cooking recipes have to be selected manually each time it is used.

### SUMMARY OF THE INVENTION

The present invention is therefore based on the technical problem of increasing the user-friendliness of kitchen appliances and at the same time promoting the use of original accessories.

This problem is solved by a kitchen appliance with a base unit having a housing, an electric motor, a detection device, a control device and a communication interface and with at least one accessory having an identification feature, which is characterised in that the detection device is configured to detect the identification feature of the at least one accessory and to forward it to the control device, in that the control device is configured to compare the detected identification feature with identification features from a database, in that the control device is configured to record the matching identification feature from the database as known and to transmit cooking information which corresponds to the matching identification feature to the control device, in that the control device is configured to mark the matching identification feature from the database as known and to make cooking information which is assigned to the matching identification feature from the database available via the communication interface if the detected identification feature matches an identification feature from the database which has already been marked as known, and in that the control device is configured to make available via the communication interface at least one cooking information which is assigned to the identification feature which has been marked as known if the detected identification feature matches an identification feature from the database which has already been marked as known.

A kitchen appliance according to the invention enables automatic registration of a registered accessory and display of the corresponding cooking information. If the accessory has already been detected at least once and has therefore already been registered, the described kitchen appliance can provide suitable cooking information directly and with minimised user effort. In particular, the recognition of an accessory makes the operation of the kitchen appliance faster and more intuitive for the user. Overall, the kitchen appliance offers increased user-friendliness, which is only accessible when using accessories with the corresponding manufacturer's features.

A base unit in the sense of the present invention is preferably designed as a base for the use of accessories by having an interface for interaction with at least one accessory. The base unit has a housing in which an electric motor for driving accessories is arranged. The electric motor interacts with an accessory assembled with the base unit via the interface of the base unit.

Accessory is understood to be any part designed for interaction with the base unit. The accessory may be directly or indirectly assembled with the base unit, wherein for direct assembly the accessory has an interface compatible with the interface of the base unit, and wherein for direct assembly the accessory is attached to further accessory which is in turn directly assembled to the base unit. The term “assemble” includes, but is not limited to, the actions from the list: Connecting, coupling, mounting, attaching, fitting and the like. In particular, an accessory is designed to extend the function of the base unit, for example as a cutting, stirring, cooking, weighing, cooking, steaming or covering unit. The function for which the accessory is intended preferably designates the type of accessory.

The term identification feature or identifier includes any information about at least one property of the accessory. Preferably, the identification feature is sufficient to identify an accessory or to be able to assign it in the context of a database with multiple cooking information. An identification feature or identifier in the sense of the invention may be selected from the non-exhaustive list: Accessory type, such as cutting, stirring, cooking, weighing, cooking, steaming or covering unit; Origin information, such as manufacturer identity, date of manufacture, place of manufacture; Authentication information; Identification number, such as a serial number or a Universally Unique Identifier (UUID). Preferably, the identification feature has been assigned by the accessory manufacturer prior to distribution.

The information feature is preferably stored on a data carrier which is integrated in the base body of the accessory or permanently attached to the base body of the accessory. Several data carriers can be provided, each of which carries an identification feature and which are arranged at different positions on the accessory. Thus, depending on the position of use or the direction in which the accessory is assembled to the base unit, an identification feature corresponding to the position of use can be detected. Alternatively or additionally, a data carrier can have several identification features, each of which is detected depending on the assembly position of the accessory on the base unit.

In particular, a data carrier can be switchable, for example with the aid of a magnet, and provide a corresponding identification feature for detection depending on the switching position or switching state. In this way, a suitable quick-start mode can be automatically called up for an accessory that can assume several operating positions on the base unit, depending on its current operating position.

The detection device or detector at the base unit is configured to detect the identification feature of the accessory. For example, if the identification feature is stored in the form of a QR code, the detection device is preferably designed as an optical reader. The detection device can also be a reader for a data memory connected to an RFID antenna, a part of a post radio system (e.g. Bluetooth, Ultra-Wide-Band (UWB) or WLAN) or a part of a bus system.

In addition, the detection device at the base unit can be connectable to a separate device via a communication link, whereby the separate device is configured to detect an identification feature and forward it to the detection device at the base unit. In this case, the separate device can be a smartphone that is configured to capture information from a QR code attached to the accessory with an identification feature.

Furthermore, the detection device may be connectable via a communication link to a detection element arranged on a first accessory. The detection element is preferably configured to detect an identification feature of a further accessory. In this way, the further accessory can first be recognised and then be used for intended use on the base unit or on the first accessory. This is particularly advantageous for accessories whose identification feature is difficult to detect in the intended use position, in particular due to insufficient signal transmission through the base of a first accessory designed as a cooking unit.

Furthermore, a control device or controller is arranged in the housing or on the housing of the base unit, which preferably comprises a processor with a storage medium. In particular, a computer program with instructions may be stored on the storage medium, the execution of which by the processor causes the kitchen appliance to perform an operating procedure. A database of cooking information and identification features may be stored on the storage medium.

Preferably, a database is stored on the storage medium of the control device such that access to an external source of information or to an external database can be dispensed with during operation. The kitchen appliance, in particular the control device, can be configured in such a way that the control device accesses an external database if the information stored in the database on the storage medium of the database is not sufficient. For example, when an accessory is used for the first time, the control device can access an external database to download cooking information for that accessory to its storage medium.

The term cooking information includes all information relating to a preparation or cooking step in connection with the Kitchen appliance. Thus, cooking information can be an operating parameter for functional parts of the kitchen appliance and/or preparation instructions for steps to be performed by the user. This includes, for example, an ingredient type, an ingredient quantity, an ingredient weight, an ingredient volume, a speed for the electric motor, a temperature, a humidity level, a duration, information from a cooking recipe, an introduction for the first use of an accessory on the base unit. Preferably, a cooking information is adapted to the characteristics of the kitchen appliance and its components so that the application of the cooking information is limited as far as possible to the use of the Kitchen appliance and its original accessories.

The control device is preferably connected to the communication interface by a bidirectional communication link so that information can be exchanged from the control device to the communication interface and also from the communication interface to the control device. Further preferred is a design of the control device for wireless access to an external database, for example via WLAN, WIFI, Bluetooth or the like. Alternatively or additionally, the control device can be designed for access to a database via a wired interface, for example in the form of a USB port or an electronic bus system.

A communication interface can be a user interface in the form of an acoustic, haptic or visual display, but also an interface for forwarding information to a user terminal such as a smartphone or a digital home management system. Thus, the communication interface provides information directly, i.e. for example itself as a display, or indirectly via an additional user interface.

The control device is configured to compare the detected identification feature with identification features from a database. In this case, the database has at least one identification feature to which applicable cooking information is assigned. Preferably, the database is stored on the storage medium of the control device. Alternatively or additionally, the database can be an external database. Applicable cooking information is that relating to the execution of a preparation step with the aid of the accessory carrying the identification feature. For example, a cooking recipe for mashed potatoes is applicable cooking information for an accessory with an identification feature corresponding to the accessory type “stirring unit”.

Cooking information can be assigned to an identification feature by the kitchen appliance manufacturer before the kitchen appliance is sold and/or subsequently by a software update. Cooking information can also be assigned in connection with the purchase of an accessory, in which cooking information is activated in the database or made accessible when a suitable accessory has been purchased. Alternatively or additionally, cooking information can be assigned identification features or be activated when a service offer has been accepted, such as an additional service on a digital user portal connected to the database. In addition, an assignment can be stored in the database by user input.

The database may be a subset of a more comprehensive database and may be available on a digital user portal of the kitchen appliance provider, subject to successful user registration.

If the comparison carried out by the control device shows that the detected identification feature corresponds to an identification feature from the database, i.e. that there is a match, then the control device checks whether the matching identification feature from the database bears a mark. If this is not the case, the matching identification feature from the database is marked as “known” and the detected identification feature or the associated accessory is registered for future use. In a further step, the control device makes the cooking information that is assigned to the matching identification feature in the database available via the communication interface.

Thus, when the accessory is used for the first time in conjunction with the base unit of the kitchen appliance, it is automatically registered and suitable cooking information is also automatically provided or suggested to the user.

If the check shows that the matching identification feature is already marked as “known”, then the control device makes the cooking information associated with this matching identification feature directly available via the communication interface. In particular, the mark may be stored in the database of the storage medium of the control device. Alternatively or additionally, the mark may be stored in an external database. Preferably, the mark is stored in the context of a digital user portal and in connection with a user identification.

This means that cooking information for an accessory that has already been registered is suggested or displayed more quickly and with less effort on the part of the user.

The control device is preferably configured to provide cooking information according to the procedure described here as a result of a corresponding user input.

According to a first embodiment of the kitchen appliance, the communication interface is adapted to detect a user input and to forward it to the control device. Furthermore, the control device is configured to mark at least one item of cooking information selected by the user input from the cooking information provided as preferred cooking information and, in the event of a subsequent, renewed match of the same identification feature, to make the at least one item of cooking information marked as preferred cooking information available separately via the communication interface.

Thus, the kitchen appliance is able to create and store an abbreviated link between an identification feature and preferred cooking information as a result of a user input regarding cooking information, in order to make it more quickly accessible when the corresponding accessory is later recognised.

A user input can in particular be a haptic, optical or sonic interaction with the communication interface. If, for example, the communication interface is designed as a touch screen or touch-sensitive screen, then this can detect a user input in the form of touching the surface of the screen.

The control device then marks the cooking information affected by the detected user input in connection with the assigned identification feature in the database as “preferred” or stores a corresponding mark for this cooking information. The storage of a mark corresponding to a user input is preferably done in the context of a user account. In this way, an optimal adaptation to individual user preferences can be offered.

A marking as “preferred” in the sense of the present invention includes any type of machine-readable indication that allows differentiation from the marked record to other records stored in the same database. For example, such a mark may be a link, an information addendum about a date, a user identity or an identification feature.

The control device provides the previously marked cooking information separately when the detected identification feature matches an identification feature from the database again, i.e. when the accessory is recognised again. By “separately” is meant a highlighted reproduction, for example in a separately displayed section of already cooked dishes, frequently selected cooking recipes or favourite preparation instructions. Also meant is a shortened access to the cooking information concerned, for example with the display of a shortcut in a digital menu.

According to another embodiment, a position detector is provided and configured to detect the position of the at least one accessory with respect to the base unit and/or with respect to another accessory and to forward it to the control device. In addition, the control device is configured to make cooking information from the database available via the communication interface depending on the detected position of the accessory.

Thus, the control device automatically detects whether an accessory is assembled and whether its position allows it to interact with the base unit as intended. In particular, a kitchen appliance of a corresponding design can automatically recognise the assembly and removal of an accessory and then also offers increased user-friendliness.

The control device provides cooking information depending on a detected position of an accessory. In this way, for example, applicable cooking information can only be made available when an assembly of an accessory is detected. This avoids providing cooking information for accessories that may well be detected by the detection device in the vicinity of the base unit and their identification feature but are not to be used at the base unit. In addition, the provision of cooking information can be terminated when the removal of an accessory from the base unit is detected. In this way, cooking information is only provided for accessories that are actually used at the base unit.

The position detector can be arranged in the accessory and/or in the housing of the base unit. Preferably, the accessory has at least one element which is configured to influence the position detector, and the position detector is configured to output a signal with position information depending on the influence by the element.

In particular, the interaction of the element of the accessory with the position detector may be designed as follows:
opening or closing an electrical contact between the element on the accessory and the position detector by changing the position of the accessory relative to the base unit;
opening or closing of a magnetic contact, for example a reed contact, between an element formed as a magnet on the accessory and the position detector by changing the position of the accessory relative to the base unit;
detecting a change in inductance or capacitance caused by interaction of a metal part on the accessory and an active detection element of the position detector; and/or
detecting the intensity of the magnetic field of a magnet arranged at the accessory by an active detection element of the position detector.

Preferably, the position detector is configured to check whether an accessory is assembled with the base unit as intended or whether its position allows successful interaction of the base unit with the accessory. In this context, it is advantageous if the control device can output a corresponding user indication via the communication interface.

The control device can be configured to first process a detected position and then a detected identification feature. In this way, the chances of success of an identification feature detection are increased, because it is more likely that a data carrier with an identification feature is located in a favourable position for the detection device if it has already been detected that the accessory is correctly assembled with the base unit.

The position of an accessory can be detected in relation to the base unit. If at least two accessories are provided, then the position of a second accessory, for example a cutting unit, can be detected in relation to the position of a first accessory, for example a mixing bowl. Overall, the position detector may be adapted to detect the position of one or more accessories and the control device may be adapted to automatically detect the assembly or removal of one or more accessories together. For example, it may be automatically detected whether an accessory is correctly assembly with or in a cooking vessel, and also whether the cooking vessel is in turn correctly assembled with the base appliance.

The control device can select cooking information from the database depending on the detected position of the accessory. Thus, the kitchen appliance is able to automatically display cooking information to the user depending on a detected accessory and the current position of the accessory.

In a further embodiment of the kitchen appliance, the control device is configured to provide cooking information from the database in dependence on a plurality of detected identification features and/or detected positions.

Such a kitchen appliance can automatically provide cooking information depending on both the type and position of several individual accessories. This can simplify the use of multiple accessories simultaneously for the user and improve the cooking experience accordingly.

In particular, the kitchen appliance is capable of automatically providing cooking information to a user that is applicable to a preparation using all of the detected accessories. Alternatively, a selection of cooking information can be provided that is applicable to individual ones of the detected accessories, so that the user can then decide which accessory(s) to use.

A further embodiment of the kitchen appliance provides that the control device is configured to block at least one preparation function if the detected identification feature does not match an identification feature from the database. Alternatively or additionally, the control device is configured to block at least one preparation function when the position of an accessory corresponding to an assembly of the accessory with the base unit is detected and the detection of an identification feature fails.

In this way, the use of third-party accessories in connection with the Kitchen appliance can be prevented, even if they have an identification feature that can be read by the detection device. In particular, third-party accessories can be excluded from use with the kitchen appliance despite the presence of an element compatible with the position detector.

Third-party identification features may be specifically absent from the database accessed by the control device. Alternatively, an identification feature originating from a third-party supplier can be stored in the database with a mark as “impermissible” and the control device can block at least one preparation function if the detected identification feature matches an identification feature marked as “impermissible”.

In particular, a preparation function is any function of the kitchen appliance that causes a preparation step. For example, the control device may selectively adjust the operation of the electric motor or a heater to disable a preparation function in the sense of the invention.

In addition, the control device can also issue a message, in particular via the communication interface, that a preparation function is blocked due to the detection of an unauthorised identification feature or foreign accessory.

The kitchen appliance can be designed in such a way that the identification feature is a coded data carrier with machine-readable information, and that the detection device is configured to detect machine-readable information.

The data carrier can in particular have a contrast image, preferably a barcode or a QR code. This makes it easy and inexpensive to mark an accessory with an identification feature. Furthermore, barcode or QR code readers are available on the market and the base unit can thus be equipped with relatively little effort.

The data carrier can be an electronic chip, a circuit board with data memory or similar. Depending on the design of the data carrier, the complexity of the coding and the amount of stored information can be set, and thus also the range of additional functions as well as the restriction of the use of third-party accessories.

According to a particular embodiment of the kitchen appliance, the identification feature is stored on an electronic data carrier and the detection device is a reader for the electronic data carrier, wherein the data carrier and the reader are connected bidirectionally by cable, in particular via a bus connection. Alternatively, the identification feature is stored on an electronic data carrier and the detection device is a reader for the electronic data carrier, wherein the reader is set up for detecting the content of the electronic data carrier by means of a radio standard, in particular by means of radio frequency identification (RFID), Bluetooth (BT) or Bluetooth Low Energy (BLE), WLAN or ultra-wide band (UWB).

Accordingly, the detection device is cable-connected to the data carrier having an identification feature, for example via a plug-and-socket principle, or the detection device reads the identification feature from the data carrier without contact.

A wired connection allows the Kitchen appliance or control device to detect an accessory with increased security and is relatively inexpensive to manufacture. Wireless detection has the advantage of being relatively insensitive to dirt, which is advantageous when using the Kitchen appliance together with food. In addition, wireless detection allows greater freedom of movement of the accessory relative to the detection device at the base unit.

According to the invention, the above-mentioned task is also solved with an accessory for a kitchen appliance with a base body in that a data carrier with an identification feature is provided, the identification feature being at least one machine-readable item of information relating to the type and/or an identification number of the accessory, and in that the data carrier is integrated in the base body.

The data carrier is integrated in the base body of the accessory and can be arranged in particular within a cavity of the base body or in a wall of the base body. In this way, the data carrier is protected from dirt and food and does not impair the appearance of the accessory. It also makes it more difficult to replicate the accessory, because the data carrier is more difficult to access.

The accessory can be designed to work together with several base units and/or be compatible with other accessories and thus be versatile.

The above-mentioned task is further solved by means of a system according to the invention with a kitchen appliance according to one of the embodiments described above and with a database, the database having identification features and cooking information associated therewith, in that the control device is set up for connection to the database via an overarching communication network.

This system offers a kitchen appliance user a wide range of preparation options and additional services that can be updated, customised and activated as desired by the kitchen appliance supplier via the database.

The overarching communication network preferably comprises an internet connection and the database is stored on a server for a user portal. Preferably, the database is an external database with respect to the base unit.

The above-mentioned task is also solved by a method for operating a Kitchen appliance, in particular a kitchen appliance according to one of the described embodiments,
wherein an identification feature of an accessory for the kitchen appliance is detected,
wherein the detected identification feature is compared with identification features from a database,
wherein, in the event of a match between the detected identification feature and an unmarked identification feature from the database, the matching identification feature from the database is marked as known, and cooking information associated with the matching identification feature from the database is provided, and
wherein, in the event of a match between the detected identification feature and an identification feature already marked as known from the database, at least one cooking information associated with the identification feature marked as known is provided.

According to a first embodiment example of the method, a user input is detected, at least one cooking information selected by the user input among the provided cooking information is marked as preferred cooking information, and in case of a later, renewed match of the same identification feature, the at least one cooking information marked as preferred cooking information is provided separately.

A further embodiment of the method provides that the position of at least one accessory is detected with respect to the base unit and/or with respect to another accessory, and that cooking information from the database is provided depending on the detected position of the accessory.

In another embodiment of the method, cooking information from the database is provided in dependence on a plurality of detected identification features and/or detected positions.

According to another embodiment of the method, at least one preparation function is blocked in the event the detected identification feature does not match an identification feature from the database, and/or at least one preparation function is blocked in the event of detecting the position of an accessory corresponding to an assembly of the accessory with the base unit and in the event of an aborted detection of an identification feature.

The method according to the invention and its embodiments have the same advantages as the kitchen appliance according to the invention and its embodiments.

Furthermore, the above-mentioned task is solved by a computer program comprising instructions, the execution of which on at least one processor of a control device of a Kitchen appliance according to one of the embodiments described above causes the execution of a method according to an embodiment example explained above.

### BRIEF DESCRIPTION OF THE DRAWINGS

Further features and advantages of the present invention will be apparent from the following description of examples of embodiments, reference being made to the accompanying drawing.

In the drawing show

FIG. 1 a first example of a kitchen appliance,

FIG. 2 an example of the system,

FIG. 3 another example of the kitchen appliance,

FIG. 4 an example of the accessory.

### DESCRIPTION OF THE INVENTION

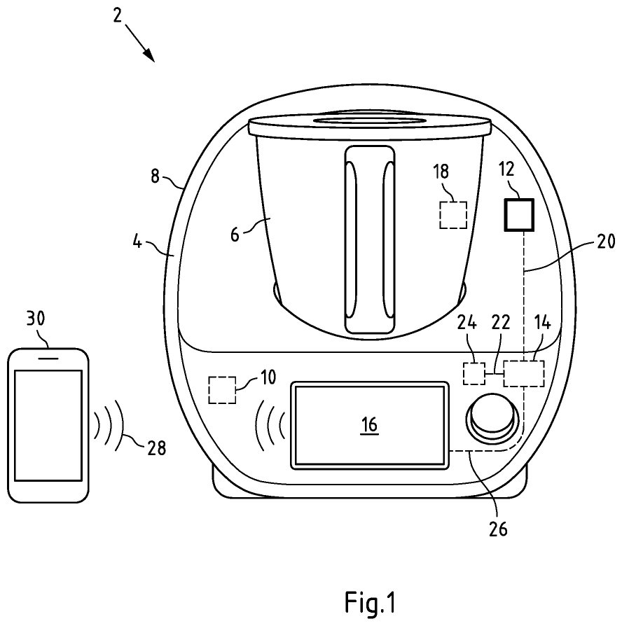

FIG. 1 shows a kitchen appliance 2 with a base unit 4 and with an accessory 6. The base unit 4 has a housing 8, an electric motor 10, a detector 12, a controller 14 and a communication interface 16. The accessory 6 is a cooking vessel on which a data carrier 18 in the form of an RFID module with a memory and an antenna is provided.

Machine-readable information concerning an identifier of the accessory 6 is stored on the memory. The identifier includes the type of the accessory 6, here “cooking vessel” and the manufacturer identification number of the accessory 6, here “111”. The detector 12 is a reader for detecting the identifier stored on the memory of the RFID module.

The detector 12 is connected to the controller 14 via a first communication link 20. The controller 14 is in turn connected to a database 24 for identifiers and cooking information associated therewith via a second communication link 22 and to the communication interface 16 via a third communication link 26. The communication interface 16 is set up for wireless data transmission 28 with a user interface 30 in the form of a smartphone.

The controller 14 comprises a processor (not shown here) with a computer program. The computer program comprises instructions, the execution of which on the processor causes a procedure to be carried out in dependence on selected cooking information from the database 24.

The kitchen appliance 2 is operated as follows. When the accessory 6 is first used with the base unit 4, the detector 12 detects the identifier of the accessory 6 and outputs a signal to the controller 14 corresponding to the information “cooking vessel” and “111”.

The controller 14 compares this information with identifiers from the database 24. The comparison results in a match of the detected information “cooking vessel” with an information “cooking vessel” stored in the database 24 which is not yet marked. The controller 14 marks the “cooking vessel” information from the database 24 with “111” or stores the manufacturer identification number “111” of the accessory 6 used together with the matching “cooking vessel” information in the database 24.

Then the controller 14 transmits cooking information stored in the database 24 together with “cooking vessel” to the user interface via the communication interface 16.

The user interface detects a user input concerning a selection of a cooking recipe and forwards a corresponding selection information to the controller 14. The controller 14 records the selected cooking information in the database 24 by storing a link between the accessory 6 “cooking vessel” with the manufacturer identification number “111” and the cooking information. In addition, the controller 14 causes the functional elements of the Kitchen appliance 2 to perform preparation steps according to the selected cooking information.

When the accessory 6 is used again at the base unit 4, the controller 14 compares the identifier detected by the detector 12 with the information stored in the database 24. The comparison results in a match of both the information “cooking vessel” and the information “111”. Thus, the accessory 6 is recognised and the controller 14 then provides the linked cooking information previously selected by user input in a separate menu on the user interface 30 via the communication interface 16.

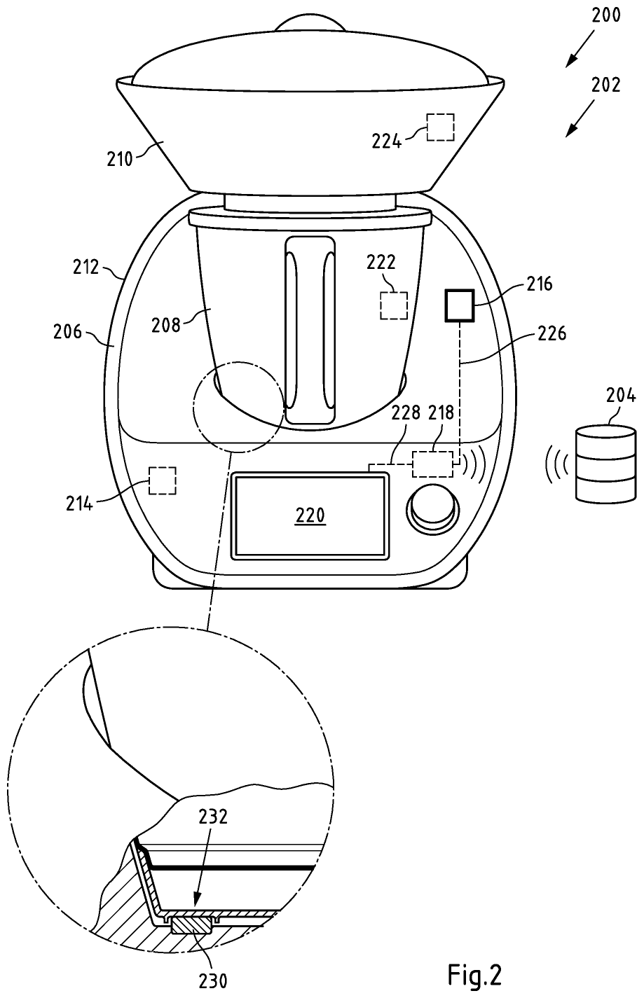

FIG. 2 shows a system 200 with a Kitchen appliance 202 and with a database 204. The Kitchen appliance 202 is equipped with a base unit 206, with a first accessory 208 and with a second accessory 210. Again, the base unit 206 comprises a housing 212, an electric motor 214, a detector 216, a controller 218 and a communication interface 220.

The first accessory 208 and the second accessory 210 are each formed as a vessel with a cutting unit and a cooking unit. The first accessory 208 serves as an interface for the use of the second accessory 210 with the base unit 206. The accessories 208, 210 each have a data carrier 222, 224 with an identifier.

The detector 216 is configured to sense the identifiers via Bluetooth transmission and the communication interface 220 is a touch-sensitive screen. The detector 216 is connected to the controller 218 via a first communication link 226, which in turn is connected to the communication interface 220 via a second communication link 228. The controller 218 is connected via radio and internet to an external database 204 for identifiers and cooking information associated therewith.

A position detector 230 is arranged at the base unit 206. The first accessory 208 has an element 232 that closes an electrical circuit of the position detector 230 when the first accessory 208 is assembled with the base unit 206.

The kitchen appliance 202 is thus able to perform the following process steps.

The user logs on to a user portal that allows access to the external database 204. He then assembles the first accessory 208 with the base unit 206, with the second accessory 210 already arranged at the first accessory 208. The element 232 at the first accessory 208 interacts with the position detector 230 such that an electrical circuit of the position detector 230 is closed and the position detector 230 outputs a corresponding signal to the controller 218. The controller 218 detects a correct assembly of the first accessory 208 with the base unit 206 and causes the detector 216 to start a detection process.

The detector 216 detects the first identifier “vessel with cutting unit; manufacturer identification number 222” and the second identifier “cooking unit; manufacturer identification number XYX” and forwards them to the controller 218. The controller 218 performs a comparison of the detected identifiers with the identifiers stored in the database 204. This results in a match with “vessel with cutting unit; manufacturer identification number 222”. However, the recorded second identifier only partially matches, i.e. only the part “cooking unit”, with the data stored in the database 204. The manufacturer identification number and its format are not recognised during the comparison or the second accessory 210 is classified as not permissible.

Accordingly, the controller 218 provides the cooking information associated with the first identifier via the communication interface 220 and outputs a signal indicating the detection of an unauthorised accessory.

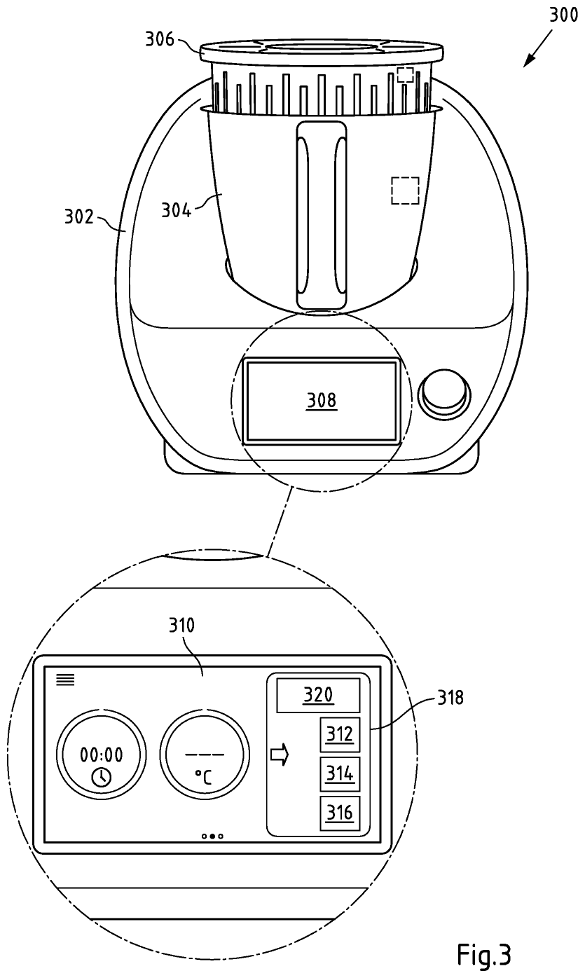

FIG. 3 shows an embodiment of the kitchen appliance 300 in which a cooking vessel is attached to the base unit 302 as the first accessory 304 and a cooking basket is attached as the second accessory 306. The communication interface 308 is in the form of a touch-sensitive screen. Also shown is an example of a menu view 310 provided to the user after assembling the accessories 304, 306 and detecting or analysing their respective identifiers. Here, the cooking information displayed is preparation instructions 312, 314, 316 that the user has selected and also performed during a previous use of the accessory combination of the cooking vessel with the cooking basket, and which have been appropriately stored in the database by the controller. The preparation instructions 312, 314, 316 are provided separately by display as heading 318 titled 320 “already cooked with the cooking basket and cooking vessel”.

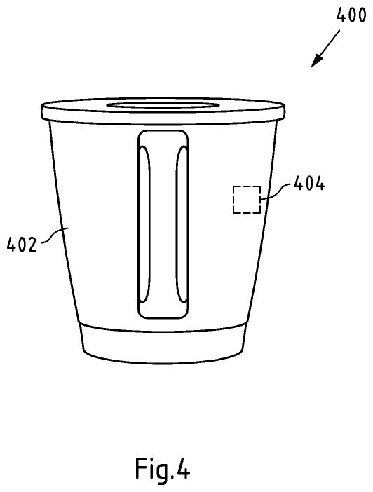

FIG. 4 shows an embodiment of the accessory 400 with a base body 402 and a data carrier 404. The data carrier 404 is integrated in the base body 402. An identifier is stored on the data carrier 404, which is machine-readable information about the type of accessory 400, in this case “cooking vessel”.

1. A kitchen appliance, wherein the kitchen appliance comprises a base unit having a housing, an electric motor, a detector, a controller and a communication interface, and at least one accessory having an identifier,
wherein the detector is configured to detect the identifier of the at least one accessory and to forward it to the controller,
wherein the controller is configured to compare the detected identifier with identifiers from a database,
wherein the controller is configured to, in the event of a match between the detected identifier and an unmarked identifier from the database,
mark the matching identifier from the database as known, and
provide cooking information associated with the matching identifier from the database via the communication interface, and
wherein the controller is configured to make available at least one item of cooking information from the database, which is assigned to the identifier marked as known, via the communication interface if the detected identifier matches an identifier already marked as known.

2. The kitchen appliance according to claim 1,
wherein the communication interface is configured to detect a user input and to forward it to the controller, and
in that the controller is configured to
mark at least one cooking information selected by the user input among the cooking information provided as preferred cooking information, and
in the event of a subsequent, renewed match of the same identifier, make the at least one item of cooking information marked as preferred cooking information available separately via the communication interface.

3. The kitchen appliance according to claim 1,
wherein a position detector is provided and is configured to detect the position of the at least one accessory with respect to the base unit and/or with respect to a further accessory and to forward it to the controller, and
wherein the controller is configured to provide cooking information from the database in dependence on the detected position of the accessory via the communication interface.

4. The kitchen appliance according to claim 1,
wherein the controller is configured to provide cooking information from the database as a function of a plurality of detected identifiers and/or detected positions.

5. The kitchen appliance according to claim 1,
wherein the controller is configured to block at least one preparation function in the event the detected identifier does not match an identifier from the database, and/or
wherein the controller is configured to block at least one preparation function in the event of detecting the position of an accessory corresponding to an assembly of the accessory with the base unit and in the event of an aborted detection of an identifier.

6. The kitchen appliance according to claim 1,
wherein the identifier is a coded data carrier with machine-readable information, and
wherein the detector is configured to detect machine-readable information.

7. The kitchen appliance according to claim 6,
wherein the identifier is stored on an electronic data carrier and the detector is a reader for the electronic data carrier, the data carrier and the reader being connected bidirectionally by cable, or
wherein the identifier is stored on an electronic data carrier and the detector is a reader for the electronic data carrier, the reader being configured to detect the content of the electronic data carrier by means of a radio standard.

8. The kitchen appliance according to claim 7,
wherein the data carrier and the reader are connected bidirectionally via a bus connection.

9. The kitchen appliance according to claim 7,
wherein the reader is configured to detect the content of the electronic data carrier by means of radio frequency identification (RFID), Bluetooth (BT), Bluetooth Low Energy (BLE), WLAN or ultra-wide band (UWB).

10. An accessory for a kitchen appliance according to claim 1,
wherein the accessory has a base body,
wherein a data carrier with an identifier is provided, the identifier being at least one machine-readable information concerning the type and/or an identification number of the accessory, and
wherein the data carrier is integrated in the base body.

11. A system,
wherein the system comprises a kitchen appliance according to claim 1, and a database,
wherein the database has identifiers and cooking information associated therewith, and
wherein the controller is configured for connection to the database via an overarching communication network.

12. A method of operating a kitchen appliance according to claim 1,
wherein an identifier of an accessory for the kitchen appliance is detected,
wherein the detected identifier is compared with identifiers from a database,
wherein, in the event of a match between the detected identifier and an unmarked identifier from the database, the matching identifier from the database is marked as known, and cooking information associated with the matching identifier from the database is provided, and
wherein, in the event of a match between the detected identifier and an identifier already marked as known from the database, at least one cooking information associated with the identifier marked as known is provided.

13. The method according to claim 12,
wherein a user input is detected,
wherein at least one item of cooking information selected by the user input from among the cooking information provided is marked as preferred cooking information, and
wherein, in the event of a subsequent, renewed match of the same identifier, the at least one cooking information marked as preferred cooking information is provided separately.

14. The method according to claim 12,
wherein the position of at least one accessory is detected with respect to the base unit and/or with respect to further accessory, and
wherein cooking information is provided from the database in dependence on the detected position of the accessory.

15. The method according to claim 12,
wherein cooking information from the database is provided in dependence on a plurality of detected identifiers and/or detected positions.

16. The method according to claim 12,
wherein at least one preparation function is blocked in the event the detected identifier does not match an identifier from the database, and/or
wherein at least one preparation function is blocked in the event of detecting the position of an accessory corresponding to an assembly of the accessory with the base unit and in the event of an aborted detection of an identifier.

17. A computer program comprising instructions, the execution of which on at least one processor of a controller of a kitchen appliance causes the performance of a method according to claim 12.
